(19) United States
(12) Patent Application Publication
(10) Pub. No.: US 2017/0236639 A1
(43) Pub. Date: Aug. 17, 2017

(54) MAGNET FABRICATION BY ADDITIVE MANUFACTURING

(71) Applicant: Digital Alloys Incorporated, Durlington, MA (US)

(72) Inventors: Forrest PIEPER, Nederland, CO (US); Alfonso PEREZ, West Palm Beach, FL (US); Paul BURKE, Framingham, MA (US)

(21) Appl. No.: 15/434,512

(22) Filed: Feb. 16, 2017

Related U.S. Application Data
(60) Provisional application No. 62/295,542, filed on Feb. 16, 2016.

(51) Int. Cl. H01F 41/02; B23K 15/00; B23K 15/02; B23K 26/342; B33Y 80/00; B23K 26/70; B33Y 10/00; B33Y 30/00; B33Y 40/00; H01F 1/04; B23K 26/08

(52) U.S. Cl. CPC H01F 41/0253; H01F 1/04; B23K 15/0086; B23K 15/002; B23K 15/02; B23K 15/0026; B23K 26/342; B23K 26/083; B23K 26/702; B33Y 10/00; B33Y 30/00; B33Y 40/00; B33Y 80/00

(57) ABSTRACT

In various embodiments, magnetic materials are fabricated in layer-by-layer fashion via additive manufacturing techniques.

### RELATED APPLICATION

This application claims the benefit of and priority to U.S. Provisional Patent Application No. 62/295,542, filed Feb. 16, 2016, the entire disclosure of which is hereby incorporated herein by reference.

### TECHNICAL FIELD

In various embodiments, the present invention relates to additive manufacturing techniques such as three-dimensional (3D) printing, and in particular to the additive manufacturing of magnetic materials.

### BACKGROUND

Magnetic materials are currently ubiquitous, being utilized in applications such as recording media, motors and generators, and medical devices such as magnetic resonance imagers. While many magnetic materials exist in nature, and many technologies are currently utilized to fabricate magnets for various applications, there remains a need for fabrication techniques for magnets in which the orientation of the internal magnetic domains (and hence the resulting magnetic field of the magnet) may be controlled at a small or large scale with high resolution.

Additive manufacturing techniques such as 3D printing are rapidly being adopted as useful techniques for a host of different applications, including rapid prototyping and the fabrication of specialty components. To date, most additive manufacturing processes have utilized polymeric materials, which are melted or solidified, layer-by-layer, into specified patterns to form 3D objects. The additive manufacturing of metallic objects has presented additional challenges, but techniques have been more recently developed to address many of these challenges. However, existing additive manufacturing techniques that fabricate objects via, for example, selective adhesion or sintering of powders in powder beds, are typically unsuitable for the fabrication of magnetic materials in which the magnetic moments of the powders require fine control and alignment.

In view of the foregoing, there is a need for improved additive manufacturing techniques for the fabrication of magnets and magnetic materials that allow fine control of the magnetic moments within the material, thereby enabling fabrication of magnets for the generation of customized and/or complicated overall magnetic fields.

### SUMMARY

In accordance with various embodiments of the present invention, magnets and magnetic materials are fabricated, via additive manufacturing techniques, in layer-by-layer fashion utilizing metal wire as feedstock. In various embodiments, the feedstock wire includes, consists essentially of, or consists of one or more ferromagnetic materials, e.g., iron, nickel, cobalt, gadolinium, and alloys containing any one or more of these materials. During fabrication, the wire is brought into proximity to, or even in contact with, a fabrication platform or a previous layer of the material being fabricated. At that point, the tip of the wire is melted by, for example, electric current flowing through the wire into the platform or a previous layer, or by a heat source such as a laser or electron beam. The tip of the wire melts to form a molten bead or “segment” that, upon cooling, forms a portion of the 3D magnetic structure. The process may proceed voxel by voxel, and thus each molten bead may cool and solidify into a “particle,” which may be in contact with neighboring particles. In various embodiments, the process proceeds sufficiently rapidly that the melting wire traces out a “segment” of the 3D magnetic structure (e.g., a linear portion) continuously rather than by formation of visibly discrete particles. A “layer” in accordance with embodiments of the present invention encompasses both continuously traced segments of the 3D structure as well as portions formed of discrete (whether in contact with each other or not) particles. In addition, a “bead” or a “segment,” as utilized herein, may solidify into and thus correspond to an individual particle, a full layer of the 3D structure, or a portion of a layer larger than an individual particle (e.g., a linear portion), i.e., a molten or solidified segment may have any length.

In various embodiments, in order to control the magnetic moment of the molten segment during deposition, a magnetic field is applied to the segment while it is in a molten state (and, in some embodiments, for a time period before melting and/or after at least partial cooling of the segment). Thus, as the molten segment cools and solidifies, the magnetic moment of the segment is aligned in response to the applied magnetic field. This process may be repeated as the 3D part is fabricated in layer-by-layer fashion, resulting in a 3D part with a customized overall magnetic moment. The applied magnetic field need not be aligned in the same direction and/or have the same amplitude for each of the molten segments, and, if desired, the magnetic field may not be applied to one or more of the segments.

The magnetic field may be applied to the molten segment using any of a number of different techniques. For example, the fabrication platform may contain therewithin (and/or extending thereabove) an electromagnet (e.g., a solenoid) that produces a magnetic field upon application of electric current. In various embodiments, the strength of the magnetic field may be altered during fabrication of the 3D part in order to compensate for the magnetic field generated by the part itself. For example, if the magnetic moment of a segment to be deposited is not desired to be aligned with the overall magnetic field produced by the incomplete part being fabricated, the strength of the magnetic field may be increased to compensate (e.g., via increased application of current to an electromagnet). Similarly, if it is desired to align the magnetic moment of a molten segment with the overall magnetic field produced by the incomplete part being fabricated, a weaker magnetic field may be required due to the influence of the part itself. In other embodiments, one or more electromagnets or permanent magnets may be disposed on, within, or below the fabrication platform. Permanent magnets disposed proximate the fabrication platform may be controllably oriented during deposition of each segment such that the desired magnetic field is applied to the segment.

In an aspect, embodiments of the invention feature a method of layer-by-layer fabrication of a magnetic object upon a baseplate. In a step (a), a tip of a wire is positioned over a top surface of the baseplate. The wire includes, consists essentially of, or consists of one or more ferromagnetic materials. In a step (b), the tip of the wire is melted to form a molten segment over the top surface of the baseplate, whereby the molten segment subsequently solidifies over the top surface of the baseplate. In a step (c), a magnetic field encompassing (and/or over) at least a portion of the top surface of the baseplate proximate the molten segment is generated, whereby a magnetic moment of the solid segment is substantially aligned with the magnetic field after solidification. In a step (d), the wire is translated relative to the baseplate (i.e., the wire is translated, the baseplate is translated, or both). In a step (e), steps (b)-(d) are repeated one or more times to form the magnetic object, each segment being formed over the baseplate or one or more previously formed and solidified segments.

Embodiments of the invention may include one or more of the following in any of a variety of combinations. One or more of the segments may correspond to an entire layer or a portion of a layer of the magnetic object. One or more of the segments may correspond to a discrete particle (e.g., a voxel-scale particle at substantially the minimum deposition resolution), which may be in contact with one or more other particles. Step (c) may be performed during at least a portion of step (d). Step (c) may be performed during at least a portion of step (b). Step (b) may include, consist essentially of, or consist of contacting the top surface of the baseplate or one or more previously formed and solidified segments with the tip of the wire and passing an electrical current between the wire and the baseplate, whereby the tip of the wire melts due to contact resistance at the tip of the wire. Steps (b), (c), and (d) may at least partially overlap each other or be performed substantially simultaneously. The molten and solidified segment may form at least a portion of a layer of the magnetic object. Step (b) may include, consist essentially of, or consist of applying energy from a high-energy source to the tip of the wire. The high-energy source may include, consist essentially of, or consist of a laser beam and/or an electron beam. The orientation of the magnetic field may be altered before, during, and/or after formation of at least two of the segments. No magnetic field (or a magnetic field having less strength) may be generated over the top surface of the baseplate during steps (a) and/or (d) (and/or portions of steps (a) and/or (d)). The wire may include, consist essentially of, or consist of iron, cobalt, nickel, gadolinium, and/or neodymium. A gas may be flowed over a tip of the wire during one or more of steps (a), (b), (c), and (d). The gas may reduce or substantially prevent oxidation of the segments during deposition and/or may increase a cooling rate of the molten segment. A computational representation of the magnetic object may be stored. Sets of data corresponding to successive layers may be extracted from the computational representation, and one or more steps may be performed in accordance with the data. A size or at least one dimension of at least one solid segment may be selected by controlling a speed of retraction of the wire therefrom (e.g., during and/or after deposition). The solid segments may be formed in response to heat arising from, at least in part (e.g., substantially entirely due to), contact resistance at the tip of the wire (i.e., resistance resulting from contact between the tip of the wire and an underlying structure, e.g., the base or an underlying segment).

In another aspect, embodiments of the invention feature an apparatus for the layer-by-layer fabrication of a three-dimensional magnetic object from segments formed by melting a ferromagnetic wire. The apparatus includes, consists essentially of, or consists of a baseplate for supporting the object during fabrication, a wire-feeding mechanism for dispensing the ferromagnetic wire over the baseplate, a magnetic field generator for generating a magnetic field encompassing (and/or over) at least a portion of a build area disposed over a top surface of the baseplate, an energy source for applying energy to a tip of the ferromagnetic wire sufficient to cause the ferromagnetic wire to form a molten ferromagnetic segment within the build area, one or more mechanical actuators (e.g., stepper motors, solenoids, linear actuators, etc.) for controlling a relative position of the base and the wire-feeding mechanism, and circuitry for controlling the one or more actuators and the energy source to create the three-dimensional magnetic object in the build area from successively released ferromagnetic segments. A magnetic moment of the ferromagnetic segment is substantially aligned with (e.g., aligned to ±10°, ±5°, ±2°, ±1°, or ±0.5° of) an orientation of the magnetic field during solidification.

Embodiments of the invention may include one or more of the following in any of a variety of combinations. The baseplate may be electrically conductive. The energy source may include, consist essentially of, or consist of a power supply for applying a current between the ferromagnetic wire and the baseplate. The ferromagnetic segment may be formed in response to contact resistance at the tip of the ferromagnetic wire. The magnetic field generator may include, consist essentially of, or consist of an electromagnet and/or a permanent magnet. The apparatus may include one or more second actuators (e.g., stepper motors, solenoids, linear actuators, etc.) for controlling the orientation of the magnetic field relative to the top surface of the baseplate. The one or more second actuators may tilt, rotate, and/or translate the magnetic field generator and/or at least a portion of the baseplate. The energy source may include, consist essentially of, or consist of a laser beam and/or an electron beam for melting the tip of the ferromagnetic wire. The circuitry may include, consist essentially of, or consist of a computer-based controller for controlling the energy source and/or the one or more mechanical actuators and/or one or more second actuators. The computer-based controller may include or consist essentially of a computer memory and a 3D rendering module. The computer memory may store a computational representation of a three-dimensional magnetic object. The 3D rendering module may extract sets of data corresponding to successive layers from the computational representation. The controller may cause the mechanical actuators and the energy source to form successive ferromagnetic segments in accordance with the data. Ferromagnetic wire may be disposed within the wire-feeding mechanism. The ferromagnetic wire may include, consist essentially of, or consist of iron, cobalt, nickel, gadolinium, and/or neodymium.

In an aspect, embodiments of the invention feature a method of layer-by-layer fabrication of a magnetic object upon a baseplate. In a step (a), a tip of a wire is positioned over a top surface of the baseplate. The wire includes, consists essentially of, or consists of one or more ferromagnetic materials. In a step (b), the tip of the wire is melted to form a molten segment over the top surface of the baseplate, whereby the molten segment subsequently solidifies over the top surface of the baseplate to form a solid segment. In a step (c), a magnetic field encompassing (and/or over) at least a portion of the top surface of the baseplate proximate the molten segment is generated, whereby a magnetic moment of the solid segment is substantially aligned with the magnetic field after solidification. In a step (d), the wire is translated relative to the baseplate (i.e., the wire is translated, the baseplate is translated, or both). In a step (e), steps (a)-(d) are repeated one or more times to form the magnetic object, each solid segment being formed over the baseplate or one or more previously formed solid segments.

Embodiments of the invention may include one or more of the following in any of a variety of combinations. Step (b) may include, consist essentially of, or consist of contacting the top surface of the baseplate or one or more previously formed solid segments with the tip of the wire and passing an electrical current between the wire and the baseplate, whereby the tip of the wire melts due to contact resistance at the tip of the wire. Step (b) may include, consist essentially of, or consist of applying energy from a high-energy source to the tip of the wire. The high-energy source may include, consist essentially of, or consist of a laser beam and/or an electron beam. The orientation of the magnetic field may be altered before, during, and/or after formation of at least two of the solid segments. No magnetic field (or a magnetic field having less strength) may be generated over the top surface of the baseplate during steps (a) and/or (d). The wire may include, consist essentially of, or consist of iron, cobalt, nickel, gadolinium, and/or neodymium. A gas may be flowed over a tip of the wire during one or more of steps (a), (b), (c), and (d). The gas may reduce or substantially prevent oxidation of the metal segments during deposition and/or may increase a cooling rate of the molten segment. A computational representation of the magnetic object may be stored. Sets of data corresponding to successive layers may be extracted from the computational representation, and one or more steps may be performed in accordance with the data. A size of at least one solid segment may be selected by controlling a speed of retraction of the wire therefrom (e.g., during and/or after deposition). The solid segments may be formed in response to heat arising from, at least in part (e.g., substantially entirely due to), contact resistance at the tip of the wire (i.e., resistance resulting from contact between the tip of the wire and an underlying structure, e.g., the base or an underlying segment).

In another aspect, embodiments of the invention feature an apparatus for the layer-by-layer fabrication of a three-dimensional magnetic object from segments formed by melting a ferromagnetic wire. The apparatus includes, consists essentially of, or consists of a baseplate for supporting the object during fabrication, a wire-feeding mechanism for dispensing the ferromagnetic wire over the baseplate, a magnetic field generator for generating a magnetic field encompassing (and/or over) at least a portion of a build area disposed over a top surface of the baseplate, an energy source for applying energy to a tip of the ferromagnetic wire sufficient to cause the ferromagnetic wire to release a ferromagnetic segment within the build area, one or more mechanical actuators (e.g., stepper motors, solenoids, linear actuators, etc.) for controlling a relative position of the base and the wire-feeding mechanism, and circuitry for controlling the one or more actuators and the energy source to create the three-dimensional magnetic object in the build area from successively released ferromagnetic segments. A magnetic moment of the ferromagnetic segment is substantially aligned with (e.g., aligned to ±10°, ±5°, ±2°, ±1°, or ±0.5°of) an orientation of the magnetic field during solidification.

Embodiments of the invention may include one or more of the following in any of a variety of combinations. The baseplate may be electrically conductive. The energy source may include, consist essentially of, or consist of a power supply for applying a current between the ferromagnetic wire and the baseplate. The ferromagnetic segment may be released in response to contact resistance at the tip of the ferromagnetic wire. The magnetic field generator may include, consist essentially of, or consist of an electromagnet and/or a permanent magnet. The apparatus may include one or more second actuators (e.g., stepper motors, solenoids, linear actuators, etc.) for controlling the orientation of the magnetic field relative to the top surface of the baseplate. The one or more second actuators may tilt, rotate, and/or translate the magnetic field generator and/or at least a portion of the baseplate. The energy source may include, consist essentially of, or consist of a laser beam and/or an electron beam for melting the tip of the ferromagnetic wire. The circuitry may include, consist essentially of, or consist of a computer-based controller for controlling the energy source and/or the one or more mechanical actuators and/or one or more second actuators. The computer-based controller may include or consist essentially of a computer memory and a 3D rendering module. The computer memory may store a computational representation of a three-dimensional magnetic object. The 3D rendering module may extract sets of data corresponding to successive layers from the computational representation. The controller may cause the mechanical actuators and the energy source to form successive layers of released ferromagnetic segments in accordance with the data. Ferromagnetic wire may be disposed within the wire-feeding mechanism. The ferromagnetic wire may include, consist essentially of, or consist of iron, cobalt, nickel, gadolinium, and/or neodymium.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, the terms “approximately” and “substantially” mean ±10%, and in some embodiments, ±5%. The term “consists essentially of” means excluding other materials that contribute to function, unless otherwise defined herein. Nonetheless, such other materials may be present, collectively or individually, in trace amounts. For example, a structure consisting essentially of multiple metals will generally include only those metals and only unintentional impurities (which may be metallic or non-metallic) that may be detectable via chemical analysis but do not contribute to function.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic of an additive manufacturing apparatus in accordance with various embodiments of the invention;

FIGS. 2A-2F are schematics of the deposition of magnetic segments during the fabrication of a three-dimensional object in accordance with various embodiments of the invention;

FIGS. 3A-3E are schematics of the deposition of a magnetic segment with a controlled magnetic moment in accordance with various embodiments of the invention;

FIGS. 4A-4C are schematics of the build area of an additive manufacturing apparatus incorporating various means of generating a magnetic field in the build area in accordance with various embodiments of the invention; and

FIG. 5 is an illustration of an additive manufacturing apparatus in accordance with various embodiments of the invention.

### DETAILED DESCRIPTION

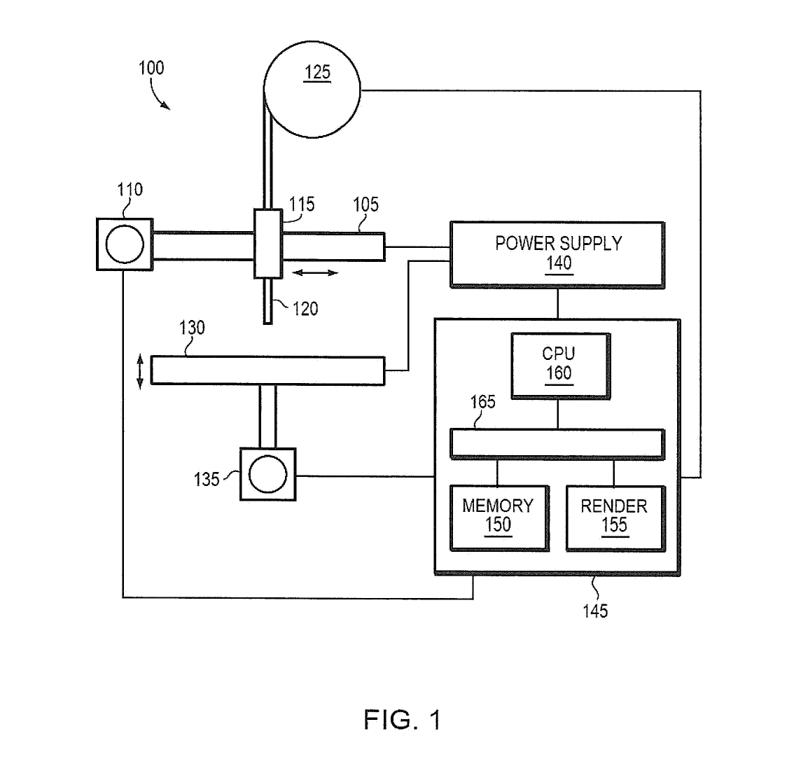

In accordance with embodiments of the invention, 3D magnetic structures may be fabricated layer-by-layer using an apparatus 100, as shown in FIG. 1 and as described in U.S. patent application Ser. No. 14/965,275, filed on Dec. 10, 2015 (the '275 application), the entire disclosure of which is incorporated by reference herein. Apparatus 100 includes a mechanical gantry 105 capable of motion in one or more of five or six axes of control (e.g., translation in and/or rotation about one or more of the XYZ planes) via one or more actuators 110 (e.g., motors such as stepper motors). As shown, apparatus 100 also includes a wire feeder 115 that positions a metal wire 120 inside the apparatus, provides an electrical connection to the metal wire 120, and continuously feeds metal wire 120 from a source 125 (e.g., a spool) into the apparatus. A baseplate 130 is also typically positioned inside the apparatus and provides an electrical connection; the vertical motion of the baseplate 130 may be controlled via an actuator 135 (e.g., a motor such as a stepper motor). An electric power supply 140 connects to the metal wire 120 and the baseplate 130, enabling electrical connection therebetween. The motion of the gantry 105 and the motion of the wire feeder 115 are controlled by a controller 145. The application of electric current from the power supply 140, as well as the power level and duration of the current, are also controlled by the controller 145. As described in more detail below, controller 145 also controls the strength and direction of the magnetic field applied to the part being fabricated by, e.g., controlling current to one or more electromagnets and/or the positioning of one or more magnets relative to the baseplate 130.

The computer-based controller 145 in accordance with embodiments of the invention may include, for example, a computer memory 150 and a 3D rendering module 155. Computational representations of 3D structures may be stored in the computer memory 150, and the 3D rendering module 155 may extract sets of data corresponding to successive layers of a desired 3D structure from the computational representation. In various embodiments, the computational representations include data specifying the desired magnetic moment of 3D structures at the voxel level (i.e., at the resolution at which the apparatus 100 is capable of printing the structures). The controller 145 may control the mechanical actuators 110, 135, wire-feeding mechanism 115, and power supply 140 to form successive layers of deposited metal segments in accordance with the data.

The computer-based control system (or “controller”) 145 in accordance with embodiments of the present invention may include or consist essentially of a general-purpose computing device in the form of a computer including a processing unit (or “computer processor”) 160, the system memory 150, and a system bus 165 that couples various system components including the system memory 150 to the processing unit 160. Computers typically include a variety of computer-readable media that can form part of the system memory 150 and be read by the processing unit 160. By way of example, and not limitation, computer readable media may include computer storage media and/or communication media. The system memory 150 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit 160. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the functions described herein. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of systems and techniques of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit 160 that executes commands and instructions may be a general-purpose computer processor, but may utilize any of a wide variety of other technologies including special-purpose hardware, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of embodiments of the invention.

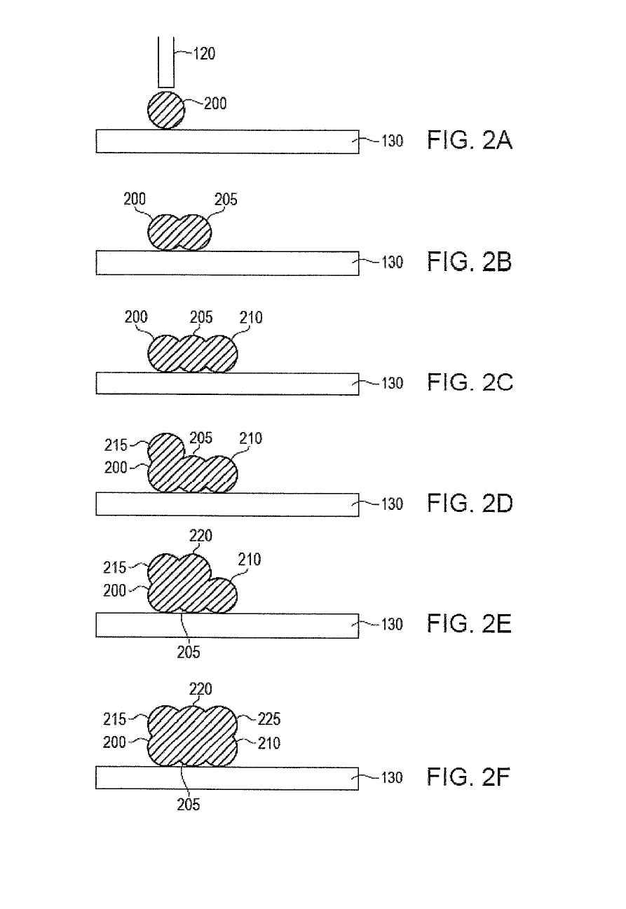

Embodiments of the invention form metal structures via metal segments formed at the molten tip of a metal wire, as shown in FIGS. 2A-2F. As illustrated, the formation of the desired 3D structure typically begins with the deposition of a single segment 200 melted from the wire 120 onto the baseplate 130. The segment 200 and subsequent segments may have any morphology but may be considered to be substantially spherical, substantially cylindrical, or even partially cylindrical (e.g., cylindrical with one or more flat surfaces). Additional segments 205, 210 are deposited one by one adjacent to previously deposited segments, and the heat from the formation of each new segment partially melts the adjacent segments and fuses them together. Once all of the segments that need to be adjacent to one another on a single layer for the desired structure have been deposited, deposition of segments 215, 220, 225 begins one by one on top of the previous layer of fused segments 200, 205, 210. Deposition continues in this manner, layer by layer, until the entire structure is completed. Each layer of the structure may be composed of a different number of segments, depending on the desired shape of the structure, and segments in an overlying layer need not be (but may be, in various embodiments) deposited directly on top of a segment of an underlying layer. The diameters of the segments will typically at least partially determine the height of each layer, and as such may at least in part dictate the resolution at which structures may be formed. The diameters and/or other dimensions of the segments may be changed by changing the diameter of the metal wire 120, as well as the deposition parameters (e.g., current level), and thus the resolution of the structure may be controlled dynamically during the process.

In various embodiments of the invention, the layers formed in accordance with FIGS. 2A-2F are formed in a substantially continuous fashion via contact-resistance-induced melting of the wire tip, and individual particles may not be discernable within a segment or a layer. Such segments or layers (or portions thereof) may have any morphology, e.g., rectangular in cross-section, substantially cylindrical, or part-cylindrical with one or more flat surfaces.

In order to protect the deposited magnetic material from oxidation, an inert gas (such as Ar) or a semi-inert gas (such as N₂ or CO₂) may be flowed over the area around the wire 120 to displace oxygen, or the part being built may be contained in a chamber filled with inert gas or semi-inert gas. For example, gas may be flowed continuously at a rate of, e.g., approximately 0.7 m3/hr during the deposition process when the metal is at high temperature or is molten.

In accordance with some embodiments of the present invention, the magnetic particles, segments (e.g., linear segments), and/or layers are formed by melting the tip of the wire 120 with electric current as described in the '275 application. The wire 120 may have a substantially circular cross-section, but in other embodiments the wire 120 has a cross-section that is substantially rectangular, square, or ovular. The diameter (or other lateral cross-sectional dimension) of the wire 120 may be chosen based on the desired properties of deposition, but generally may be between approximately 0.1 mm and approximately 1 mm. The wire 120 is one electrode, and the metallic baseplate 130 of the apparatus 100 is the other electrode, as shown in FIG. 1. When the wire 120 is in physical contact with the baseplate 130, the two are also in electrical contact. There is an electrical resistance between the wire 120 and baseplate 130 (i.e., contact resistance) due to the small cross-sectional area of the fine wire 120 and the microscopic imperfections on the surface of the baseplate 130 and the tip of the wire 120. The contact resistance between the wire 120 and baseplate 130 is the highest electrical resistance experienced by an electric current that is passed between the two electrodes (i.e., the wire 120 and baseplate 130), and the local area at the contact point is heated according to Joule's First Law. The heat generated is in excess of the heat required to melt the tip of the wire 120 into a particle, segment, layer, or layer portion, and to fuse the deposited metal to previously deposited metal. The heat is determined by the amount of current, the contact resistance between the wire 120 and baseplate 130, and the duration of the application of current. (Thus, embodiments of the present invention form particles, segments, and layers without use or generation of electrical arcs and/or plasma, but rather utilize contact-resistance-based melting of the wire.) Current and time may be controlled during the process via controller 145 and power supply 140, and in various embodiments of the invention, a high current is utilized for a short duration (as opposed to a lower current for a longer duration) to increase the speed of deposition. The required current and duration depends on the desired deposition properties, but these may generally range from approximately 10 Amperes (A) to approximately 2000 A and approximately 0.005 seconds (s) to approximately 1 s. After the first layer is completed, the previous layer, which is in electrical contact with the baseplate 130, act as the second electrode. As the process proceeds, one electrode (the metal wire 120) is consumed as metal from the tip of the wire 120 is utilized to form the layers of the object.

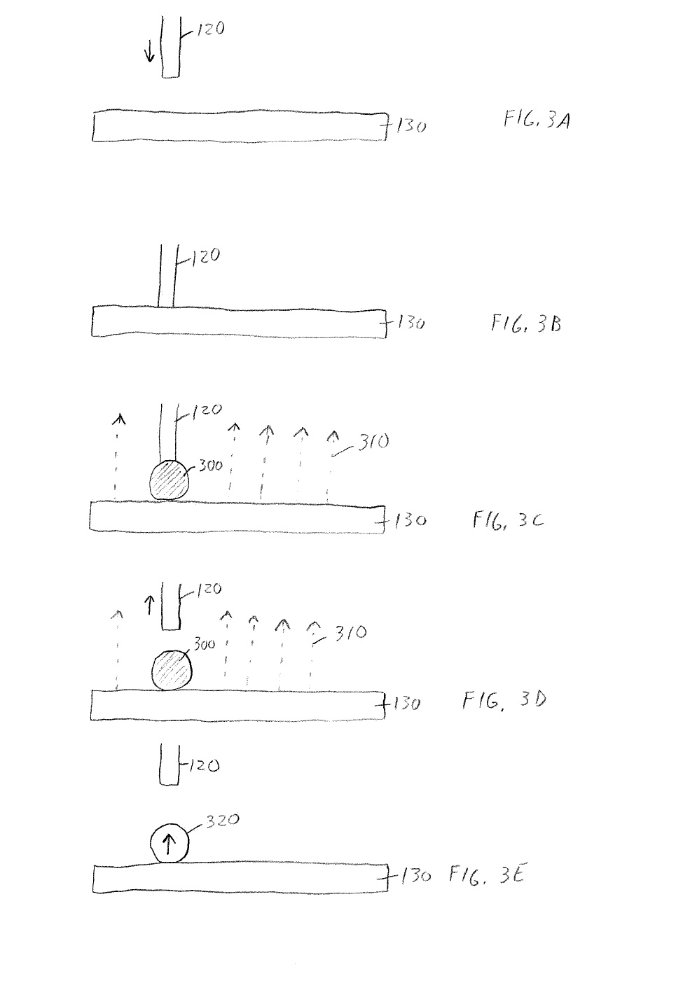

FIGS. 3A-3E schematically depict the deposition of an exemplary magnetic metal segment in accordance with various embodiments of the present invention. As shown in FIGS. 3A and 3B, the wire 120 is lowered toward the surface of the baseplate 130 until the tip of the wire 120 makes contact therewith. The wire 120 typically includes, consists essentially of, or consists of one or more ferromagnetic materials such as iron, nickel, cobalt, gadolinium, rare-earth metal alloys (e.g., neodymium alloys), and alloys containing any one or more of these materials. At the point depicted in FIG. 3B, when the tip of the wire 120 makes contact with the surface of the baseplate 130, electrical current from the power supply 140 is applied to the baseplate 130 in order to initiate the formation of the metal segment (or particle or layer or layer portion) via melting of the tip of the wire 120 by contact-resistance-induced heating. As shown in FIG. 3C, application of the electrical current continues and results in the formation of a molten segment 300 composed of the material of the wire 120. At this point, a magnetic field 310 is also applied to the build area proximate the molten segment 300 in order to align the magnetic moment of the molten segment 300 (via, e.g., rearrangement of the molten segment 300 at the atomic or domain level) with the direction of the electric field 310. Once sufficient melting of the tip of the wire 120 has occurred to form the molten segment 300 of the desired size, the electrical current may be shut off and the wire 120 is retracted away from the segment 300, as shown in FIG. 3D. At this point, the segment 300 may remain at least partially molten; thus, in various embodiments the magnetic field 310 remains applied even after termination of the electrical current and retraction of the wire 120. As shown in FIG. 3E, the molten segment 300 rapidly cools into a solid segment 320 having a magnetic moment substantially aligned with the direction of the magnetic field 310, and the magnetic field 310 may be shut off in preparation for deposition of the next segment. Subsequent segments may be deposited in the manner depicted in FIGS. 2A-2F proximate (e.g., alongside, above, and/or in direct contact with) the segment 320 under applications of magnetic field 310 that may be, but is not necessarily, aligned in the same direction as during deposition of segment 320. In this manner, the final 3D printed part may be fabricated to possess a desired magnetic field of any level of complexity.

In various embodiments of the invention, as detailed above, the deposition of an entire layer (or portion thereof) of the 3D magnetic structure may be formed substantially continuously rather than by formation of discrete particles. In such embodiments, the magnetic field 310 may be applied during substantially the entire deposition, and the tip of the wire may not be retracted before the wire is translated relative to the baseplate 130. In this manner, the molten segment 300 may be an elongated layer or layer portion whose magnetic moment aligns with the direction of the magnetic field 310 during cooling. In various embodiments, the direction of the magnetic field 310 may be altered during deposition of a layer (or portion thereof), even if the deposition is continuous.

In various embodiments of the invention, the magnetic moment of the wire 120 itself is substantially random across its volume in order to reduce or substantially eliminate magnetic interactions caused by the wire 120 itself during fabrication. For example, the wire 120 may be formed by a powder metallurgy technique in which particles of one or more ferromagnetic metals are pressed and sintered into a rod-like preform, which may subsequently be reduced in diameter by one or more mechanical deformation steps such as rolling, extrusion, and/or drawing. The magnetic moments of the individual powder particles may be substantially random during fabrication of the wire 120 so that the wire 120 itself does not exhibit a strong directional magnetic field.

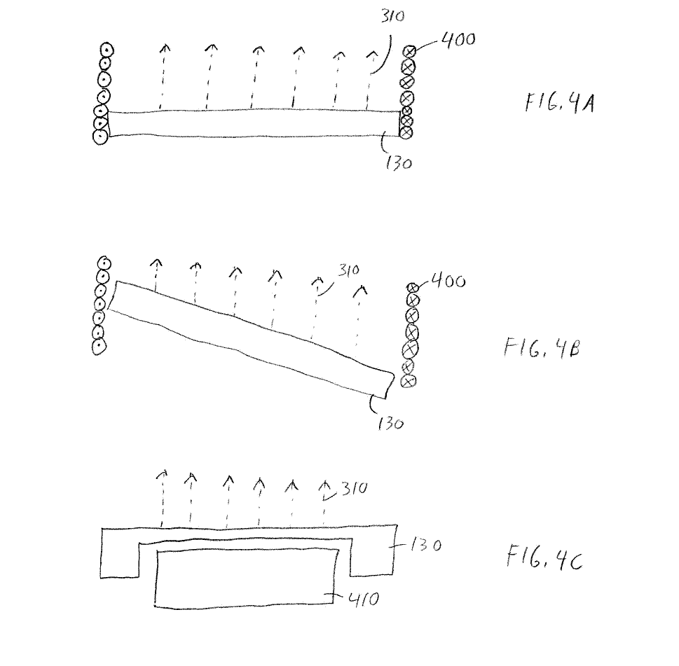

The magnetic field 310 applied during formation of magnetic particles, segments, and layers (and assembly thereof to form 3D magnetic parts) may be formed and controlled via any of a number of different techniques. As shown in FIG. 4A, an electromagnet 400 may be utilized to form the magnetic field 310 within the build area above the baseplate 130. The electromagnet 400 may be disposed over and/or below the top surface of the baseplate 130, and in some embodiments all or a portion of the electromagnet 400 may be disposed within the baseplate 130 itself. The electromagnet 400 may include, consist essentially of, or consist of, for example, a solenoid coil that forms magnetic field 310 when current (e.g., from power supply 140 or from a separate dedicated power source) is applied thereto. The strength of the magnetic field 310 may be altered by altering the amount of current flowing through the electromagnet 400; for example, increasing the current typically increases the strength of the magnetic field 310.

As shown in FIG. 4B, the direction of the magnetic field 310 relative to the top surface of the baseplate 130 may be altered by angling the baseplate 130 with respect to the electromagnet 400. For example, controller 145 may be utilized with, e.g., one or more actuators to tilt or rotate the baseplate 130 and/or the electromagnet 400. While FIG. 4B depicts the baseplate 130 as being tilted while the electromagnet 400 remains in its original orientation, in other embodiments of the invention the electromagnet 400 may be reoriented while the baseplate 130 remains level or both the electromagnet 400 and the baseplate 130 may be tilted or rotated.

The magnetic field 310 may also be produced and shaped via the use of one or more permanent magnets 410, as shown in FIG. 4C. As shown, one or more permanent magnets 410 may be disposed below and/or within the baseplate 130 such that the magnetic field produced thereby extends into the build area above the top surface of the baseplate 130. As described above for electromagnet 400, the direction and strength of the magnetic field 310 may be altered via relative rotation between the baseplate 130 and the permanent magnet 410, e.g., rotation of the baseplate 130, rotation of the permanent magnet 410, or both. One or more of the permanent magnets 410 may be moved farther away from the build area (e.g., away from baseplate 130) in order to modulate the strength of the magnetic field 310 within the build area.

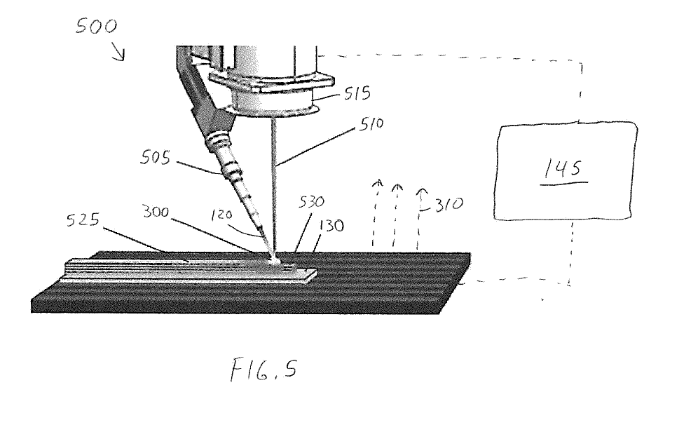

While exemplary embodiments of the invention described herein have utilized the apparatus depicted in FIG. 1 and wire heating and melting resulting from contact resistance concomitant with electrical power being applied between the baseplate and the wire, embodiments of the invention may utilize different apparatuses and different techniques of melting the metal feedstock wire. For example, FIG. 5 depicts an apparatus 500 in accordance with embodiments of the invention for additive manufacturing of magnetic materials and objects. As shown, the wire 120 may be incrementally fed, using a wire feeder 505, into the path of a high-energy source 510 (e.g., an electron beam or a laser beam emitted by a laser or electron-beam source 515), which melts the tip of the wire 120 to form the molten segment 300. The entire assembly 500 may be disposed within a vacuum chamber to prevent or substantially reduce contamination from the ambient environment.

Relative movement between the baseplate 130 (which may be, as shown, disposed on a platform 520 that may contain, include, consist essentially of, or consist of one or more magnets for application of magnetic field 310) supporting the deposit and the wire/gun assembly results in the part being fabricated in a layer-by-layer fashion. Such relative motion may result in, for example, the continuous formation of a layer 525 of the 3D magnetic object from formation of the molten segments 300 at the tip of the wire 120. As shown in FIG. 5, all or a portion of layer 525 may be formed over one or more previously formed layers 530. The relative movement (i.e., movement of the platform 520 and/or baseplate 130, the wire/gun assembly, or both) may be controlled by controller 145 as detailed above. The magnetic field 310 may be applied to the build area while each molten segment 300 is solidifying as described above with respect to FIGS. 3A-3E. The source 510 may be pulsed such that each molten segment 300 may at least partially solidify (and thus possess a set magnetic moment) before formation of the next molten segment 300, or the formation of the molten segments 300 may proceed continuously during application of the magnetic field 310. In this manner, the fabrication process proceeds similarly to the layer-formation process detailed above, but the molten segment 300 is formed via melting induced by the source 510 rather than by contact resistance between the wire and the baseplate 130 (or a previously deposited layer thereon). As detailed above, the magnetic field 310 may be produced utilizing an electromagnet 400 and/or one or more permanent magnets 410, which are not shown in FIG. 5 for clarity.

In various embodiments, the apparatus 100 may also be utilized to fabricate electromagnets utilizing ferromagnetic objects fabricated via the layer-by-layer fabrication processes detailed within (e.g., solidification of successively formed molten segments 300). Once the 3D ferromagnetic object has been fabricated, an insulated wire may be fed into the wire feeder 115, and the tip of the wire may be attached to the surface of the baseplate 130 proximate the ferromagnetic object. For example, the tip of the wire may be brought into contact with the baseplate and current may be applied between the wire and the baseplate via power supply 140. Rather than releasing a molten segment in response to the current flow, the current may be shut off before the wire is retracted, and the tip of the wire, having softened or at least partially melted in response to contact resistance-induced heating, remains attached to the surface of the baseplate. The controller 145 may then control the movements of the wire feeder 115 to encircle the ferromagnetic object one or more times to coil the insulated wire around the ferromagnetic object. Thereafter, the wire may be severed by a wire cutter disposed within the wire feeder 115 or by a human operator, completing the fabrication of the electromagnet. In various embodiments, the insulated wire may be dispensed from a secondary wire feeder within apparatus 100, rather than the wire feeder 115 utilized to fabricate the ferromagnetic object.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of layer-by-layer fabrication of a magnetic object upon a baseplate, the method comprising:
(a) positioning a tip of a wire over a top surface of the baseplate, the wire comprising one or more ferromagnetic materials;
(b) melting the tip of the wire to form a molten segment over the top surface of the baseplate, whereby the molten segment subsequently solidifies over the top surface of the baseplate;
(c) generating a magnetic field encompassing the top surface of the baseplate proximate the molten segment, whereby a magnetic moment of the segment is substantially aligned with the magnetic field after solidification;
(d) translating the wire relative to the baseplate; and
(e) repeating steps (b)-(d) one or more times to form the magnetic object, each segment being formed over the baseplate or one or more previously formed and solidified segments.

2. The method of claim 1, wherein step (b) comprises:
contacting the top surface of the baseplate or one or more previously formed and solidified segments with the tip of the wire; and
passing an electrical current between the wire and the baseplate, whereby the tip of the wire melts due to contact resistance at the tip of the wire.

3. The method of claim 1, wherein steps (b), (c), and (d) are performed substantially simultaneously, the molten and solidified segment forming at least a portion of a layer of the magnetic object.

4. The method of claim 1, wherein step (b) comprises applying energy from a high-energy source to the tip of the wire.

5. The method of claim 4, wherein the high-energy source comprises a laser beam or an electron beam.

6. The method of claim 1, further comprising altering an orientation of the magnetic field during formation of at least two of the segments.

7. The method of claim 1, wherein no magnetic field is generated over the top surface of the baseplate during step (a).

8. The method of claim 1, wherein no magnetic field is generated over the top surface of the baseplate during at least a portion of step (d).

9. The method of claim 1, wherein the wire comprises at least one of iron, cobalt, nickel, gadolinium, or neodymium.

10. The method of claim 1, further comprising flowing a gas over a tip of the wire during at least step (b), the gas (i) reducing or substantially preventing oxidation of the segments during deposition and/or (ii) increasing a cooling rate of the molten segment.

11. An apparatus for the layer-by-layer fabrication of a three-dimensional magnetic object from segments formed by melting a ferromagnetic wire, the apparatus comprising:
a baseplate for supporting the object during fabrication;
a wire-feeding mechanism for dispensing the ferromagnetic wire over the baseplate;
a magnetic field generator for generating a magnetic field encompassing a build area disposed over a top surface of the baseplate;
an energy source for applying energy to a tip of the ferromagnetic wire sufficient to cause the ferromagnetic wire to form a molten ferromagnetic segment within the build area, a magnetic moment of the ferromagnetic segment being substantially aligned with an orientation of the magnetic field during solidification;
one or more mechanical actuators for controlling a relative position of the base and the wire-feeding mechanism; and
circuitry for controlling the one or more actuators and the energy source to create the three-dimensional magnetic object in the build area from successively formed ferromagnetic segments.

12. The apparatus of claim 11, wherein:
the baseplate is electrically conductive; and
the energy source comprises a power supply for applying a current between the ferromagnetic wire and the baseplate, the ferromagnetic segment being formed in response to contact resistance at the tip of the ferromagnetic wire.

13. The apparatus of claim 11, wherein the magnetic field generator comprises at least one of an electromagnet or a permanent magnet.

14. The apparatus of claim 11, further comprising one or more second actuators for controlling the orientation of the magnetic field relative to the top surface of the baseplate.

15. The apparatus of claim 11, wherein the energy source comprises at least one of a laser beam or an electron beam for melting the tip of the ferromagnetic wire.

16. The apparatus of claim 11, wherein the circuitry comprises a computer-based controller for controlling at least one of the energy source or the one or more mechanical actuators.

17. The apparatus of claim 11, further comprising ferromagnetic wire within the wire-feeding mechanism.

18. The apparatus of claim 17, wherein the ferromagnetic wire comprises at least one of iron, cobalt, nickel, gadolinium, or neodymium.
